(19) United States
(12) Patent Application Publication
(10) Pub. No.: US 2010/0128013 A1
(43) Pub. Date: May 27, 2010

(54) PLASMA DISPLAY DEVICE

(75) Inventors: Sang Yoon SOH, Gumi-si (KR); Ju Won SEO, Gumi-si (KR); Hyun Oh LEE, Gumi-si (KR); Yun Kwon JUNG, Gumi-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/511,413

(22) Filed: Jul. 29, 2009

(30) Foreign Application Priority Data
Nov. 21, 2008 (KR) 10-2008-0116358

(51) Int. Cl. G09G 3/28; G09G 5/00

(52) U.S. Cl. 345/211; 345/60

(57) ABSTRACT

A plasma display device is provided. The plasma display device can reduce the capacity of a pass switch necessary for various driving circuits for applying various driving signals to a plasma display panel (PDP) and can thus contribute to the reduction of the manufacturing cost. In addition, the plasma display device can reduce the amount of heat generated by the various driving circuits and can thus contribute to the improvement of the reliability and the reduction of the power consumption.

This application claims priority from Korean Patent Application No. 10-2008-0116358 filed on Nov. 21, 2008 in the Korean Intellectual Property Office, the disclosure of which is incorporated herein by reference in its entirety.

### BACKGROUND OF THE INVENTION

1. Field of the Invention

The present invention relates to a plasma display device, and more particularly, to an apparatus for driving a plasma display panel (PDP) of a plasma display device.

2. Description of the Related Art

In general, plasma display panels (PDPs) include an upper substrate, a lower substrate and a plurality of barrier walls which are formed between the upper and lower substrates and define a plurality of cells that can be filled with a main-discharge gas such as neon (Ne), helium (He) or a mixture of neon and helium (Ne+He) and an inert gas containing a small amount of xenon (Xe). PDPs are generally thin and have a simple structure. Thus, PDPs have long been popular as next-generation displays.

In the meantime, in order to display a PDP, various driving circuits may be required for applying various driving signals to electrodes formed on the PDP. Each of the various driving circuits may include a plurality of switches for properly controlling driving signals. However, the switches may generate heat after a long use and may thus cause a waste of energy.

### SUMMARY OF THE INVENTION

The present invention provides an apparatus for driving a plasma display panel (PDP) of a plasma display device.

According to an aspect of the present invention, there is provided a plasma display device equipped with a plasma display panel (PDP), the plasma display device including a sustain-driving unit which includes a sustain-up switch and a sustain-down switch applying a sustain voltage and a ground voltage, respectively, to the PDP when turned on; a scan-driving unit which includes a scan-up switch and a scan-down switch applying a scan voltage and the ground voltage, respectively, to the PDP when turned on; a reset-driving unit which includes a set-up switch and a set-down switch applying a setup voltage and a negative voltage, respectively, to the PDP when turned on; and a pass switch which has a first end connected to at least one of the sustain-up switch and the set-up switch and a second end connected to the sustain-down switch.

According to another aspect of the present invention, there is provided a plasma display device equipped with a plasma display panel (PDP), the plasma display device including: a sustain-driving unit which includes a sustain-up switch and a sustain-down switch applying a sustain voltage and a ground voltage, respectively, to the PDP when turned on; a scan-driving unit which includes a scan-up switch and a scan-down switch applying a scan voltage and the ground voltage, respectively, to the PDP when turned on; a reset-driving unit which includes a set-up switch and a set-down switch applying a setup voltage and a negative voltage, respectively, to the PDP when turned on; and a pass switch which separates at least one of a path for supplying the setup voltage to the PDP and a path for supplying the sustain voltage to the PDP from a path for supplying the ground voltage to the PDP.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a perspective view of a plasma display panel (PDP) according to an exemplary embodiment of the present invention;

FIG. 2 illustrates a cross-sectional view for explaining the arrangement of electrodes in a PDP;

FIG. 3 illustrates a timing diagram for explaining a time-division method of driving a PDP in which a frame is divided into a plurality of subfields;

FIG. 4 illustrates a timing diagram showing the waveforms of a plurality of driving signals for driving a PDP;

FIG. 5 illustrates a circuit diagram of a driving circuit for driving a PDP;

FIG. 6 illustrates a circuit diagram of a plasma display device according to an exemplary embodiment of the present invention;

FIG. 7 illustrates a circuit diagram of a plasma display device according to another exemplary embodiment of the present invention;

FIG. 8 illustrates a circuit diagram of a plasma display device according to another exemplary embodiment of the present invention; and

FIG. 9 illustrates a circuit diagram of a plasma display device according to another exemplary embodiment of the present invention.

### DETAILED DESCRIPTION OF THE INVENTION

The present invention will hereinafter be described in detail with reference to the accompanying drawings in which exemplary embodiments of the invention are shown.

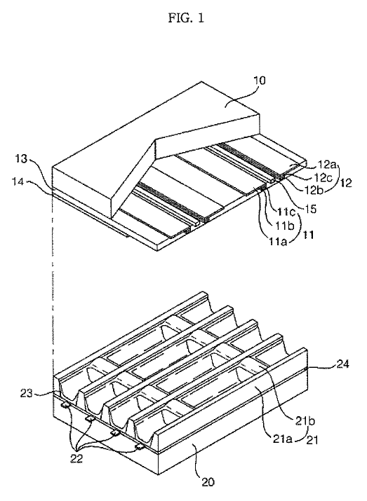

FIG. 1 illustrates a perspective view of a plasma display panel according to an exemplary embodiment of the present invention. Referring to FIG. 1, the PDP may include an upper substrate 10, a plurality of electrode pairs formed on the upper substrate 10; a lower substrate 20, and a plurality of address electrodes 22 formed on the lower substrate 20. Each of the electrode pairs may include a scan electrode 11 and a sustain electrode 12.

More specifically, each of the electrode pairs may include transparent electrodes 11a and 12a and bus electrodes 11b and 12b. The transparent electrodes 11a and 12a may be formed of indium-tin-oxide (ITO). The bus electrodes 11b and 12b may be formed of a metal such as silver (Ag) or chromium (Cr) or may include a stack of chromium/copper/chromium (Cr/Cu/Cr) or a stack of chromium/aluminum/chromium (Cr/Al/Cr). The bus electrodes 11b and 12b may be respectively formed on the transparent electrodes 11a and 12a and may reduce a sudden voltage drop caused by the transparent electrodes 11a and 12a having high resistance.

Alternatively, each of the electrode pairs may only include the bus electrodes 11b and 12b. In this case, it is possible to reduce the manufacturing cost of a plasma display device. The bus electrodes 11b and 12b may be formed of various materials, other than those set forth herein, such as a photosensitive material.

Black matrices may be formed on the upper substrate 10. The black matrices may perform a light shied function by absorbing external light incident upon the upper substrate 10 so as to reduce the reflection of light. In addition, the black matrices may enhance the purity and contrast of the upper substrate 10.

More specifically, the black matrices may include a first black matrix 15 overlapping a plurality of barrier ribs 21, a second black matrix 11c formed between the transparent electrode 11a and the bus electrode 11b of each of the scan electrodes 11, and a second black matrix 12c formed between the transparent electrode 12a and the bus electrode 12b. The first black matrix 15 and the second black matrices 11c and 12c, which can also be referred to as black layers or black electrode layers, may be formed at the same time and may be physically connected. Alternatively, the first black matrix 15 and the second black matrices 11c and 12c may not be formed at the same time, and may be physically disconnected.

If the first black matrix 15 and the second black matrices 11c and 12c are physically connected, the first black matrix 15 and the second black matrices 11c and 12c may be formed of the same material. On the other hand, if the first black matrix 15 and the second black matrices 11c and 12c are physically disconnected, the first black matrix 15 and the second black matrices 11c and 12c may be formed of different materials.

An upper dielectric layer 13 and a passivation layer 14 may be deposited on the upper substrate 10 where the scan electrodes 11 and the sustain electrodes 12 are formed in parallel with one other. Charged particles generated as a result of a discharge may accumulate in the upper dielectric layer 13. The upper dielectric layer 13 may protect the electrode pairs. The passivation layer 14 may protect the upper dielectric layer 13 from sputtering of the charged particles and may enhance the discharge of secondary electrons.

The address electrodes 22 may intersect the scan electrode 11 and the sustain electrodes 12. A lower dielectric layer 23 and the barrier ribs 21 may be formed on the lower substrate 20 where the address electrodes 22 are formed.

A phosphor layer may be formed on the lower dielectric layer 23 and the barrier ribs 21. The barrier ribs 21 may include a plurality of vertical barrier ribs 21a and a plurality of horizontal barrier ribs 21b that form a closed-type barrier rib structure. The barrier ribs 21 may define a plurality of discharge cells and may prevent the infiltration of ultraviolet (UV) rays and visible rays generated by a discharge into the discharge cells.

The present invention can be applied to various barrier rib structures, other than that set forth herein. For example, the present invention can be applied to a differential barrier rib structure in which the height of vertical barrier ribs 21a is different from the height of horizontal barrier ribs 21b, a channel-type barrier rib structure in which a channel that can be used as an exhaust passage is formed in at least one vertical or horizontal barrier rib 21a or 21b, and a hollow-type barrier rib structure in which a hollow is formed in at least one vertical or horizontal barrier rib 21a or 21b. In the differential barrier rib structure, the height of horizontal barrier ribs 21b may be greater than the height of vertical barrier ribs 21a. In the channel-type barrier rib structure or the hollow-type barrier rib structure, a channel or a hollow may be formed in at least one horizontal barrier rib 21b.

Red (R), green (G), and blue (B) discharge cells may be arranged in line. However, the present invention is not restricted to this. That is, R, G, and B discharge cells may be arranged in various manners, other than that set forth herein. For example, a group of R, G and B discharge cells may be arranged in a polygonal pattern such as a triangular, rectangular, pentagonal or hexagonal pattern.

The phosphor layer may be excited by UV rays that are generated upon a gas discharge. As a result, the phosphor layer may generate one of R, G, and B rays. A discharge space may be provided between the upper and lower substrates 10 and 20 and the barrier ribs 21. A mixture of inert gases, e.g., a mixture of helium (He) and xenon (Xe), a mixture of neon (Ne) and Xe, or a mixture of He, Ne, and Xe may be injected into the discharge space.

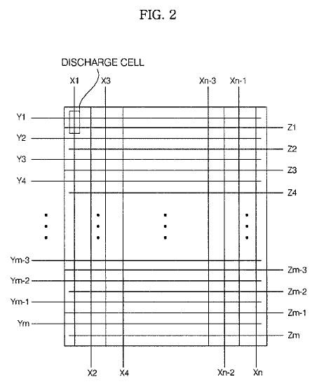

FIG. 2 illustrates the arrangement of electrodes in a PDP. Referring to FIG. 2, a plurality of discharge cells of a PDP may be arranged in a matrix. The discharge cells are respectively disposed at the intersections between a plurality of scan electrode lines Y₁ through Yₘ and a plurality of address electrode lines X₁ through Xₙ or the intersections between a plurality of sustain electrode lines Z₁ through Zₘ and the address electrode lines X₁ through Xₙ. The scan electrode lines Y₁ through Yₘ may be sequentially or simultaneously driven. The sustain electrode lines Z₁ through Zₘ may be simultaneously driven. The address electrode lines X₁ through Xₙ may be divided into two groups: a group including odd-numbered address electrode lines and a group including even-numbered address electrode lines. The address electrode lines X₁ through Xₙ may be driven in units of the groups or may be sequentially driven.

The electrode arrangement illustrated in FIG. 2, however, is exemplary, and thus, the present invention is not restricted to this. For example, the scan electrode lines Y₁ through Yₘ may be driven using a dual scan method in which two of a plurality of scan lines are driven at the same time. The address electrode lines X₁ through Xₙ may be divided into two groups: a group including a number of upper address electrode lines disposed in the upper half of a PDP and a group including a number of lower address electrode lines disposed in the lower half of the PDP. Then, the address electrode lines X₁ through Xₙ may be driven in units of the two groups.

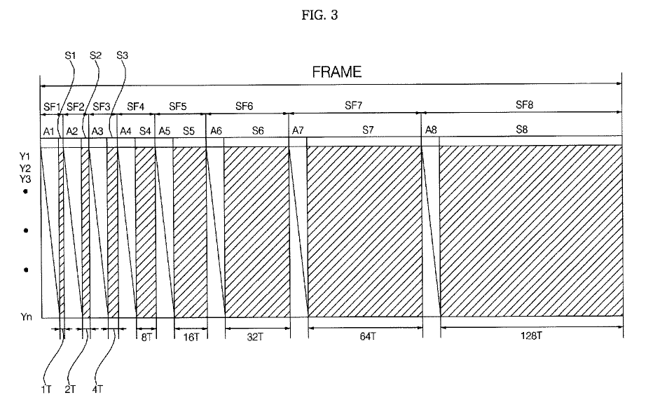

FIG. 3 illustrates a timing diagram for explaining a time-division method of driving a PDP in which a frame is divided into a plurality of subfields. Referring to FIG. 3, a unit frame may be divided into a predefined number of subfields, for example, eight subfields SF1 through SF8, in order to realize a time-division grayscale display. Each of the subfields SF1 through SF8 may be divided into a reset period (not shown), an address period (A1, . . . , A8), and a sustain period (S1, . . . , S8).

Some of the subfields SF1 through SF8 may have a reset period. For example, the first subfield SF1 may have a reset period. Alternatively, the first subfield and any subfield in the middle of the frame may both have a reset period.

During each of the address periods A1 through A8, a display data signal may be applied to address electrodes X, and a scan pulse may be applied to scan electrodes Y. As a result, a number of wall charges may be generated in discharge cells.

During each of the sustain periods S1 through S8, a number of sustain pulses may be alternately applied to the scan electrodes Y and sustain electrodes Z. As a result, a number of sustain discharges may be generated in discharge cells.

The luminance of a PDP may be proportional to the total number of sustain discharge pulses applied during each frame. If each frame includes eight subfields and can be represented using 256 grayscale levels, 1, 2, 4, 8, 16, 32, 64, and 128 sustain pulses may be configured to be applied during the sustain periods S1, S2, S3, S4, S5, S6, S7, and S8, respectively. In this case, a grayscale level of 133 may be realized by addressing a discharge cell may be addressed during the first, third, and eighth subfields SF1, SF3, and SF8, respectively, so as to cause a total of 133 sustain discharges.

The number of sustain discharges that can be applied during each of the subfields SF1 through SF8 may be determined by a weight applied to a corresponding subfield through automatic power control (APC). Referring to FIG. 3, each frame may be divided into eight subfields, but the present invention is not restricted to this. In other words, each frame may be divided into less than eight or more than eight subfields (e.g., twelve or sixteen subfields).

The number of sustain discharges that can be applied during each of the subfields SF1 through SF8 may be determined by the properties of a PDP such as a gamma property. For example, the subfield SF4 may be configured to realize a grayscale level of 6, instead of a grayscale level of 8, and the subfield SF6 may be configured to realize a grayscale level of 34, instead of a grayscale level of 32.

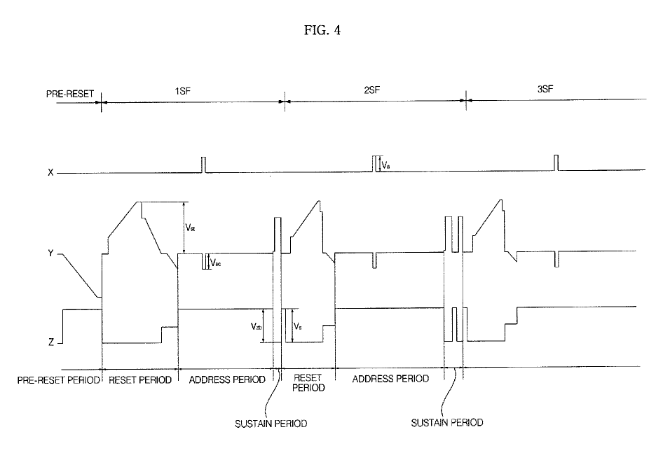

FIG. 4 illustrates a timing diagram showing the waveforms of a plurality of driving signals for driving a PDP during one of the subfields SF1 through SF4 shown in FIG. 3, according to an embodiment of the present invention. Referring to FIG. 4, a pre-reset period is followed by a first subfield. During the pre-reset period, positive wall charges are generated on scan electrodes Y and negative wall charges are generated on sustain electrodes Z. A subfield may include a reset period for initializing the discharge cells of a previous frame with reference to the distribution of wall charges generated during the pre-reset period, an address period for selecting a number of discharge cells, and a sustain period for enabling the selected discharge cells to cause a number of sustain discharges.

A reset period may include a set-up period during and a set-down period. During a set-up period, a ramp-up waveform is applied to all the scan electrodes Y at the same time so that all discharge cells each can cause a weak discharge, and that wall charges can be generated in the discharge cells, respectively.

During a set-down period, a ramp-down waveform whose voltage decreases from a positive voltage that is lower than a peak voltage of the ramp-up waveform is applied to all the scan electrodes Y so that each of the discharge cells can cause an erase discharge, and that whichever of the wall charges generated during the set-up period and space charges are unnecessary can be erased.

During an address period, a scan signal having a negative level may be sequentially applied to the scan electrodes Y, and a data signal having a positive level may be applied to the address electrodes X. Due to the difference between the scan signal and the data signal and the wall charges generated during the reset period, a number of address discharges may occur. As a result of the address discharges, a number of discharge cells may be selected. During a set-down period and an address period, a signal for maintaining the voltage of the sustain electrodes at a sustain-voltage level may be applied to the sustain electrodes Z during an address period.

During an address period, the scan electrodes Y may be divided into two or more groups, and a scan signal may be sequentially applied to each of the groups. Each of the groups may be divided into two or more sub-groups, and a scan signal may be sequentially applied to each of the sub-groups. For example, the scan electrodes Y may be divided into a first group and a second group. Then, a scan signal may be sequentially applied to a number of scan electrodes Y included in the first group. Thereafter, a scan signal may be sequentially applied to a number of scan electrodes Y included in the second group.

During a sustain period, a sustain pulse is alternately applied to the scan electrodes Y and the sustain electrodes Z so that surface discharges can occur between the scan electrodes Y and the respective sustain electrodes Z as sustain discharges.

The waveforms illustrated in FIG. 4 are exemplary, and thus, the present invention is not restricted thereto. For example, the pre-reset period may be optional. In addition, the polarities and voltages of driving signals used to drive a PDP are not restricted to those illustrated in FIG. 4, and may be altered in various manners. An erase signal for erasing wall charges may be applied to each of the sustain electrodes Z after a sustain discharge. The sustain signal may be applied to either the scan electrodes Y or the sustain electrodes Z, thereby realizing a single-sustain driving method.

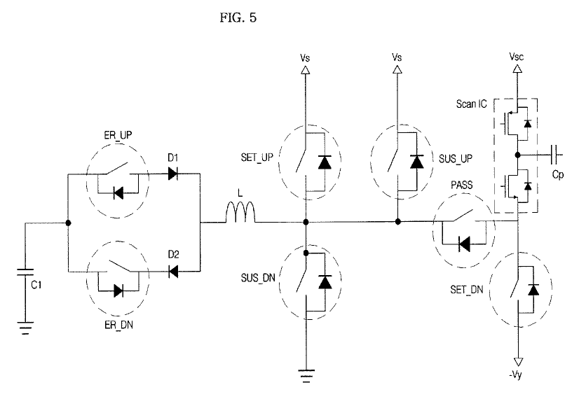

FIG. 5 illustrates a circuit diagram of a driving circuit for driving a PDP. Referring to FIG. 5, the driving circuit may include an energy-recovery unit, a sustain-driving unit, a reset-driving unit and a scan integrated circuit (IC).

The sustain-driving unit may include a sustain-voltage source Vs which supplies a high sustain voltage during a sustain period, a sustain-up switch SUS_UP which applies the sustain voltage to scan electrodes when turned on, and a sustain-down switch SUS_DN which drops the voltage of the scan electrodes to a ground-voltage level when turned on.

The driving circuit may also include a pass switch PASS which applies the output of the sustain-driving unit to a PDP when turned on and an inductor L which is necessary for constituting a resonation circuit.

The energy-recovery unit may include a source capacitor C1 which recovers energy from or supplies energy to the scan electrodes, an energy-supply switch ER_UP which supplies the energy stored in the source capacitor C1 to the scan electrodes when turned on, and an energy-recovery switch ER_DN which recovers energy from the scan electrodes when turned on.

The reset-driving unit may include a set-up switch SET_UP which applies a setup signal whose level gradually increases to the scan electrodes when turned on, and a set-down switch SET_DN which applies a set-down signal whose level decreases to a negative voltage to the scan electrodes when turned on.

The drain of the set-up switch SET_UP may be connected to the sustain-voltage source Vs, the source of the set-up switch SET_UP may be connected to the scan IC, and the gate of the set-up switch SET_UP may be connected to a variable resistor (not shown). The setup signal may be generated by the variable resistor whose resistance varies.

The scan IC may include a scan-up switch which applies a scan voltage Vsc to the scan electrodes when turned on and a scan-down switch which applies a ground voltage or a negative voltage to the scan electrodes when turned on.

The pass switch PASS, which is disposed on a main discharge path, may allow various driving waveforms to be applied to a PDP when switched on. Since the driving circuit includes various voltage sources and a set-down operation or a scan operation can be performed even at a negative bias level, the pass switch PASS may be necessary in order to prevent the generation of an inverse current and to properly form a main discharge path.

However, since the pass switch PASS has large capacity, the waveforms of various driving signals may be distorted, and the margins for a sustain voltage may be adversely affected by, for example, an overshoot voltage.

Not only the energy-supply switch ER_UP and the energy-recovery switch ER_DN but also the sustain-up switch SUS_UP and the sustain-down switch SUS_DN may be connected to the drain of the pass switch PASS, and all the current generated in the driving circuit may be applied to a PDP via the pass switch PASS. Thus, the pass switch PASS is highly likely to generate heat. In order to address this problem, more than one pass switch PASS may be provided in the driving circuit, or a large-scale heat sink may be connected to the driving circuit. In this case, however, the manufacturing cost of a plasma display device may increase.

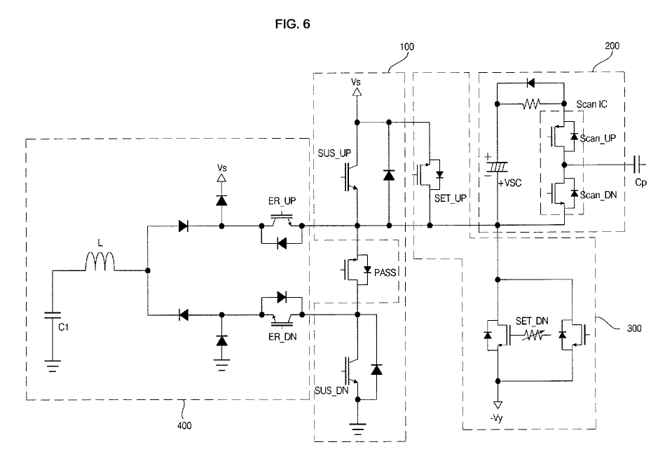

FIG. 6 illustrates a circuit diagram of a plasma display device according to an exemplary embodiment of the present invention. Referring to FIG. 6, the plasma display device may include a PDP Cp, a sustain-driving unit 100, a scan driving unit 200, a reset-driving unit 300, and a pass switch PASS. The sustain-driving unit 100 may include a sustain-up switch SUS_UP and a sustain-down switch SUS_DN which apply a sustain voltage and a ground voltage, respectively, to the PDP Cp when turned on. The scan-driving unit 200 may include a scan-up switch Scan_UP and a scan-down switch Scan_DN which apply a scan voltage Vsc and the ground voltage, respectively, to the PDP Cp when turned on. The reset-driving unit 300 may include a set-up switch SET_UP and a set-down switch SET_DN which apply a setup voltage and a negative voltage, respectively, to the PDP Cp when turned on. At least one of the sustain-up switch SUS_UP and the set-up switch SET_UP may be connected to a first end of the pass switch PASS, and the sustain-down switch SUS_DN may be connected to a second end of the pass switch PASS.

The pass switch PASS may separate at least one of a path for supplying the setup voltage to the PDP Cp and a path for supplying the sustain voltage to the PDP Cp from a path for supplying the ground voltage to the PDP Cp.

More specifically, referring to FIG. 6, the sustain-driving unit 100 may include a sustain-voltage source Vs supplying a high sustain voltage during a sustain period, the sustain-up switch SUS_UP applying the sustain voltage to a number of scan electrodes when turned on, and the sustain-down switch SUS_DN dropping the voltage of the scan electrodes to a ground-voltage level when turned on.

The pass switch PASS may be connected between the sustain-up switch SUS_UP and the sustain-down switch SUS_DN. Each of the pass switch PASS and the sustain-down switch SUS_DN may include a body diode. The body diodes of the pass switch PASS and the sustain-down switch SUS_DN may face opposite directions.

The reset-driving unit 300 may include the set-up switch SET_UP applying a setup voltage whose level gradually increases to the scan electrodes when turned on, a negative voltage source −Vy, and the set-down switch SET_DN applying a set-down voltage whose level drops to a negative level to the scan electrodes when turned on.

A variable resistor (not shown) may be connected to the gates of the set-up switch SET_UP and the set-down switch SET_DN. Thus, a signal whose level gradually varies according to the resistance of the variable resistor may be generated.

The reset-driving unit 300 may also include an additional switch connected to the negative voltage source −Vy for quickly generating a negative voltage such as a scan pulse.

The scan-driving unit 200 may include a scan IC. The scan IC may include the scan-up switch Scan_UP which applies the scan voltage Vsc to the scan electrodes when turned on and the scan-down switch Scan_DN which applies the ground voltage or a negative voltage to the scan electrodes when turned on. The scan-driving unit 200 may also include various circuits other than a scan-voltage source and the scan IC, such as a resistor and a diode.

The operations of the sustain-up switch SUS_UP, the sustain-down switch SUS_DN, the scan-up switch Scan_UP, the scan-down switch Scan-DN, the set-up switch SET_UP, and the set-down switch SET_DN are similar to the operations of their respective counterparts shown in FIG. 5, and thus, the exemplary embodiment of FIG. 6 will be described in further detail, focusing mainly on the operation of the pass switch PASS, which is connected between the sustain-up switch SUS_UP and the sustain-down switch SUS_DN.

When the sustain-up switch SUS_UP and the pass switch PASS are turned on and the sustain-down switch SUS_DN is turned off, the path of supplying the ground voltage may be blocked, and the sustain voltage may be supplied to the PDP Cp.

On the other hand, when the sustain-down switch SUS_DN is turned on and the sustain-up switch SUS_UP and the pass switch PASS are turned off, the PDP Cp may be connected to a ground voltage source via the body diode of the pass switch PASS. Thus, the sustain voltage may be removed from the PDP Cp, and the ground voltage may be supplied to the PDP Cp.

In the plasma display device shown in FIG. 6, the energy-supply switch ER_UP and the sustain-up switch SUS_UP may be connected to the source of the pass switch PASS, whereas, in the driving circuit shown in FIG. 5, the sustain-up switch SUS_UP and the sustain-down switch SUS_DN are both connected to one end of the pass switch PASS.

The pass switch may separate at least one of the path for supplying the setup voltage to the PDP Cp and the path for supplying the sustain voltage to the PDP Cp from the path for supplying the ground voltage to the PDP Cp. That is, a current generated during the supply of energy to the PDP Cp by an energy-recovery circuit and a high sustain current may be directly applied to the scan electrodes (i.e., the PDP Cp) without passing through the pass switch PASS. Given that the current generated during the supply of energy to the PDP Cp by the energy-recovery circuit and a high sustain current may account for more than half of the current applied to the PDP Cp, the capacity of the pass switch PASS may be reduced to less than half, compared to a conventional pass switch.

In addition, since the amount of current passing through the pass switch PASS can be reduced and thus the amount of heat generated by the pass switch PASS can be reduced, the size of a heat sink necessary for the pass switch PASS and the manufacturing cost of a plasma display device can also be reduced.

Moreover, it is possible to prevent the generation of an inverse current and reduce the amount of energy lost from the pass switch PASS by appropriately controlling the turning on or off of the pass switch PASS.

The sustain-up switch SUS_UP may need to be designed to be able to endure a voltage higher than the sustain voltage. For this, an insulated gate bipolar transistor with high voltage resistance may be used as the sustain-up switch SUS_UP or the pass switch PASS.

The plasma display device may also include an energy-recovery unit 400. The energy-recovery unit 400 may include a source capacitor C1 which is charged with a voltage recovered from the PDP Cp, an inductor L which forms a resonation circuit with the source capacitor C1, an energy-supply switch ER_UP which supplies the voltage stored in the source capacitor C1 to the PDP Cp when turned on and an energy-recovery switch ER_DN which recovers the voltage supplied to the PDP Cp when turned on.

More specifically, referring to FIG. 6, the source capacitor C1 may recover energy from or supply energy to the scan electrodes. The energy-supply switch ER_UP may supply the energy stored in the source capacitor C1 to the scan electrodes when turned on. The energy-recovery switch ER_DN may recover energy from the scan electrodes when turned on.

The source capacitor C1 may recover energy from the PDP Cp and may store the recovered energy therein. The inductor L may form a resonation circuit together with a capacitance component of the PDP Cp and the source capacitor C1. The energy-supply switch ER_UP and the energy-recovery circuit ER_DN, which are connected between the inductor L and the PDP Cp, may recover a voltage supplied to the PDP Cp during a sustain-discharge operation and may supply the recovered voltage again to the PDP Cp during the application of a sustain signal to the PDP Cp.

The sustain-up switch SUS_UP may be connected to the sustain-voltage source Vs and may supply the sustain voltage to the PDP Cp when turned on. The sustain-down switch SUS_DN may be connected to the ground-voltage source, and may drop the voltage of the PDP Cp to the ground-voltage level when turned on.

The operation of the energy-recovery unit 400 will hereinafter be described in further detail. When the plasma display device is turned on and thus a number of discharges occur consecutively, a discharge current may be applied to the source capacitor C1 from the PDP Cp via the inductor L. As a result, the source capacitor C1 may be filled with the discharge current.

Thereafter, when the energy-supply switch ER_UP is turned on, a voltage that the source capacitor C 1 may be charged with may be supplied to the PDP Cp, and thus, the level of the sustain voltage applied to the PDP Cp may gradually increase.

Thereafter, when the sustain-up switch SUS_UP is turned on, the level of the sustain signal applied to the PDP Cp may be maintained at a sustain-voltage level.

Thereafter, when the energy-recovery switch ER_DN is turned on, the energy that the PDP Cp is charged with may be recovered. Then, the recovered energy may be applied to the source capacitor C1 via the inductor L, and thus, the source capacitor C1 may be charged with the recovered energy. As a result, the level of the sustain signal applied to the PDP Cp may gradually decrease.

Thereafter, when the sustain-down switch SUS_DN is turned on, the level of the sustain signal applied to the PDP Cp may rapidly drop to and may then be maintained at a reference-voltage level, for example, the ground-voltage level.

That is, during the supply of energy to the PDP Cp and the recovery of energy from the PDP Cp, the source capacitor C1, the capacitance component of the PDP Cp and the inductor L may form a resonation circuit together. Due to the resonation of the resonation circuit, the energy that the source capacitor C1 is charged with may be supplied to the PDP Cp via the inductor, or the energy that the PDP is charged with may be supplied to the source capacitor C1.

A first terminal of the inductor L may be directly connected to the source capacitor C1. The voltage of a second terminal of the inductor L may be distorted by unnecessary resonations. In this case, since the inductor L is directly connected to the source capacitor C1, instead of being connected to the PDP Cp, and a voltage supplied to the first terminal of the inductor L can be switched with a voltage applied to the source capacitor C1, it is possible to prevent the occurrence of unnecessary resonations.

The pass switch PASS may be connected between the energy-supply switch ER_UP and the energy-recovery switch ER_DN.

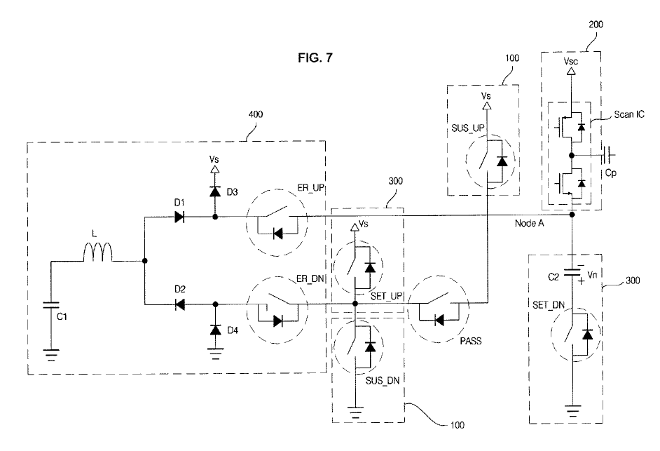

FIG. 7 illustrates a circuit diagram of a plasma display device according to another exemplary embodiment of the present invention. Referring to FIG. 7, the plasma display device may include a PDP Cp, a sustain-driving unit 100, a scan-driving unit 200, a reset-driving unit 300, an energy-recovery unit 400 and a pass switch PASS. The sustain-driving unit 100 may include a sustain-up switch SUS_UP and a sustain-down switch SUS_DN. The scan-driving unit 200 may include a scan IC. The reset-driving unit 300 may include a set-up switch SET_UP and a set-down switch SET_DN. The energy-recovery unit 500 may include a source capacitor C1 which is charged with a voltage recovered from the PDP Cp, an inductor L which forms a resonation circuit together with the source capacitor C1, an energy-supply switch ER_UP which supplies the voltage that the source capacitor C1 is charged with to the PDP Cp when turned on, and an energy-recovery switch ER_DN which recovers a voltage from the PDP Cp when turned on. The energy-recovery switch ER_DN may be connected to the pass switch PASS.

The places of the set-up switch SET_UP and the sustain-up switch SUS_UP may be switched.

The pass switch PASS may be connected to the energy-recovery switch ER_DN and the sustain-down switch SUS_DN or may be connected between the energy-supply switch ER_UP and the energy-recovery switch ERN_DN.

The set-down switch SET_DN may be connected between a second capacitor C2 and a ground-voltage source, and may supply a negative voltage to the PDP Cp when turned on.

More specifically, the drain of the set-down switch SET_DN may be connected to a first end of the second capacitor C2. A second end of the second capacitor C2 may be connected to the scan IC. The source of the set-down switch SET_DN may be connected to the ground-voltage source. An operating voltage Vcc may be supplied to the gate of the set-down switch SET_DN.

When the set-down switch SET_DN is switched on and thus the voltage at a node between the set-down switch SET_DN and the second capacitor C2 decreases to a ground-voltage level, the electric potential difference between the first and second ends of the second capacitor C2 may become the same as a voltage Vn, and a node A may be coupled so that its voltage can decrease to a negative-voltage level −Vn. The voltage Vn may be a voltage supplied by a voltage supply unit (not shown) such as a direct current/direct current (DC/DC) converter. The second capacitor C2 may be charged with the voltage Vn or may be directly connected to the voltage supply unit supplying the voltage Vn.

Since the voltage at the source of the set-down switch SET_DN is not a negative voltage but a ground voltage, an additional gate-driver IC or floating-power-supply circuit and an additional negative-voltage source may be unnecessary.

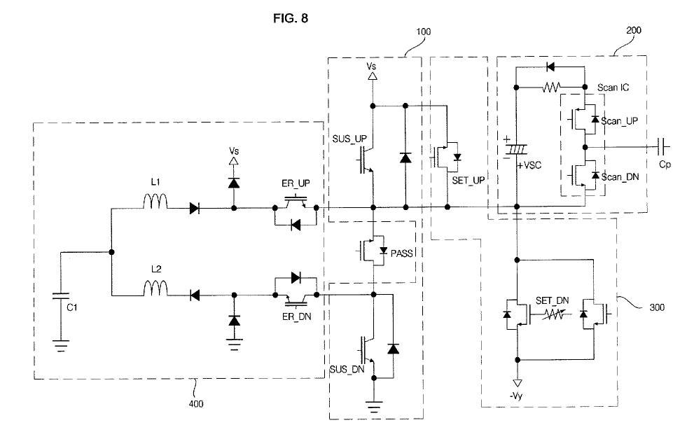

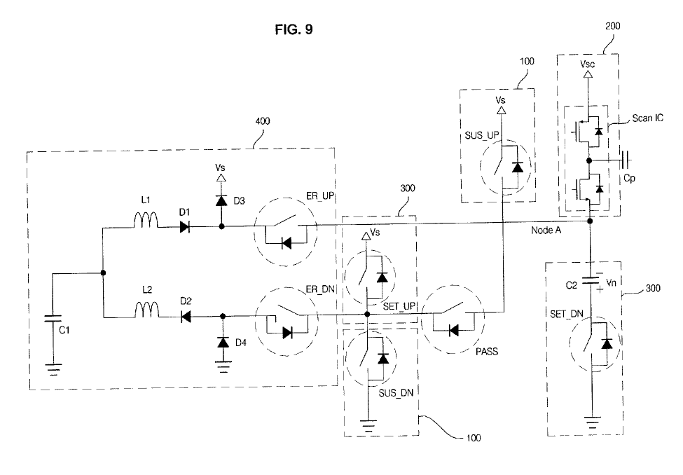

FIGS. 8 and 9 illustrate circuit diagrams of plasma display devices according to other exemplary embodiments of the present invention. The plasma display devices shown in FIGS. 8 and 9 are almost the same as the plasma display devices shown in FIGS. 6 and 7 except for the structure of an energy-recovery unit 400.

Referring to FIG. 8 or 9, an energy-recovery unit 400 may include an energy-supply switch ER_UP, an energy-recovery switch ER_DN, a source capacitor C1 and first and second inductors L1 and L2. The first inductors L1 and L2 may be connected to the energy-supply switch ER_UP and the energy-recovery switch ER_DN, respectively, and may form a resonation circuit together with the source capacitor C1.

More specifically, referring to FIG. 8, the energy-recovery unit 400 may include the first inductor L1 which is connected to the energy-supply switch ER_UP and forms a resonation circuit together with the source capacitor C1 during the supply of energy to a number of scan electrodes by the source capacitor C1, and the second inductor L2 which is connected to the energy-recovery switch ER_DN and forms a resonation circuit together with the source capacitor C1 during the recovery of energy from the scan electrodes by the source capacitor C1.

During the supply of energy to the scan electrodes in response to a sustain signal, the energy-supply switch ER_UP may be turned on, and thus, the source capacitor C1 and the first inductor L1 may form a resonation circuit together. As a result, a current passing through the first inductor L1 may gradually increase from its minimum to maximum and may then gradually decrease from its maximum to minimum, and thus, a voltage supplied to the scan electrodes may gradually increase.

On the other hand, during the recovery of energy from the scan electrodes in response to the sustain signal, the energy-recovery switch ER_DN may be turned on, and thus, the source capacitor C1 and the second inductor L2 may form a resonation circuit together. As a result, a current passing through the second inductor L2 may gradually increase from its minimum to maximum and may then gradually decrease from its maximum to minimum, and thus, the voltage supplied to the scan electrodes may gradually decrease.

Therefore, it is possible to delicately adjust an energy-supply period and an energy-recovery period by using the first and second inductors L1 and L2.

In order to secure sufficient margins for the driving of a high-resolution PDP, a sustain-up switch SUS_UP may be turned on and may thus supply a sustain voltage to the scan electrodes before the current passing through the first inductor L1 reaches its minimum. Similarly, a sustain-down switch SUS_DN may be turned on and may thus supply a ground voltage to the scan electrodes before the current passing through the second inductor L2 reaches its minimum.

Therefore, it is possible to secure sufficient margins for the driving of a PDP. In addition, it is possible to secure a sufficient duration for the maintenance of a sustain voltage and thus to stably cause a sustain-discharge operation. Moreover, it is possible to reduce delays in the sustain-discharge operation.

As described above, according to the present invention, it is possible to reduce the capacity of a pass switch necessary for various driving circuits for applying various driving signals to a PDP and thus to reduce the manufacturing cost of a plasma display device. In addition, it is possible to reduce the amount of heat generated by the various driving circuits and thus to improve the reliability of a plasma display device and reduce the power consumption of the plasma display device.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display device equipped with a plasma display panel (PDP), the plasma display device comprising:
a sustain-driving unit which includes a sustain-up switch and a sustain-down switch applying a sustain voltage and a ground voltage, respectively, to the PDP when turned on;
a scan-driving unit which includes a scan-up switch and a scan-down switch applying a scan voltage and the ground voltage, respectively, to the PDP when turned on;
a reset-driving unit which includes a set-up switch and a set-down switch applying a setup voltage and a negative voltage, respectively, to the PDP when turned on; and
a pass switch which has a first end connected to at least one of the sustain-up switch and the set-up switch and a second end connected to the sustain-down switch.

2. The plasma display device of claim 1, wherein each of the pass switch and the sustain-down switch includes a body diode, the body diodes of the pass switch and the sustain-down switch facing opposite directions.

3. The plasma display device of claim 1, further comprising an energy-recovery unit which includes a source capacitor charged with a voltage recovered from the PDP, an inductor forming a resonation circuit together with the source capacitor, an energy-supply switch supplying the voltage that the source capacitor is charged with to the PDP when turned on and an energy-recovery switch recovering a voltage from the PDP when turned on.

4. The plasma display device of claim 3, wherein the pass switch is connected to the energy-recovery switch and the sustain-down switch.

5. The plasma display device of claim 3, wherein the pass switch is connected between the energy-supply switch and the energy-recovery switch.

6. The plasma display device of claim 3, wherein the inductor is directly connected to the source capacitor.

7. The plasma display device of claim 3, wherein the inductor includes first and second inductors connected to the energy-supply switch and the energy-recovery switch, respectively, and forming a resonation circuit with the source capacitor.

8. The plasma display device of claim 1, wherein at least one of the sustain-up switch and the pass switch is an insulated gate bipolar transistor.

9. A plasma display device equipped with a plasma display panel (PDP), the plasma display device comprising:
a sustain-driving unit which includes a sustain-up switch and a sustain-down switch applying a sustain voltage and a ground voltage, respectively, to the PDP when turned on;
a scan-driving unit which includes a scan-up switch and a scan-down switch applying a scan voltage and the ground voltage, respectively, to the PDP when turned on;
a reset-driving unit which includes a set-up switch and a set-down switch applying a setup voltage and a negative voltage, respectively, to the PDP when turned on; and
a pass switch which separates at least one of a path for supplying the setup voltage to the PDP and a path for supplying the sustain voltage to the PDP from a path for supplying the ground voltage to the PDP.

10. The plasma display device of claim 9, wherein the pass switch has a first end connected to at least one of the sustain-up switch and the set-up switch and a second end connected to the sustain-down switch.

11. The plasma display device of claim 9, wherein each of the pass switch and the sustain-down switch includes a body diode, the body diodes of the pass switch and the sustain-down switch facing opposite directions.

12. The plasma display device of claim 9, further comprising an energy-recovery unit which includes a source capacitor charged with a voltage recovered from the PDP, an inductor forming a resonation circuit together with the source capacitor, an energy-supply switch supplying the voltage that the source capacitor is charged with to the PDP when turned on and an energy-recovery switch recovering a voltage from the PDP when turned on.

13. The plasma display device of claim 12, wherein the pass switch is connected to the energy-recovery switch and the sustain-down switch.

14. The plasma display device of claim 12, wherein the pass switch is connected between the energy-supply switch and the energy-recovery switch.

15. The plasma display device of claim 12, wherein the inductor is directly connected to the source capacitor.

16. The plasma display device of claim 12, wherein the inductor includes first and second inductors connected to the energy-supply switch and the energy-recovery switch, respectively, and forming a resonation circuit with the source capacitor.

17. The plasma display device of claim 9, wherein at least one of the sustain-up switch and the pass switch is an insulated gate bipolar transistor.
